(19) United States
(12) Patent Application Publication
(10) Pub. No.: US 2010/0043894 A1
(43) Pub. Date: Feb. 25, 2010

(54) VALVE ELEMENT, PARTICLE ENTRY PREVENTIVE MECHANISM, EXHAUST CONTROL APPARATUS, AND SUBSTRATE PROCESSING APPARATUS

(75) Inventors: Tsuyoshi Moriya, Nirasaki-shi (JP); Eiichi Sugawara, Nirasaki-shi (JP); Morihiro Takanashi, Nirasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Tokyo (JP)

(21) Appl. No.: 12/511,721

(22) Filed: Jul. 29, 2009

(30) Foreign Application Priority Data
Jul. 30, 2008 (JP) 2008-196270

(51) Int. Cl. F16K 51/00

(52) U.S. Cl. 137/544; 251/356

(57) ABSTRACT

A valve element that can prevent particles rebounding from an exhausting pump from entering a chamber and also prevent a decrease in exhaust efficiency. The valve element has a through hole that penetrates the valve element along an exhaust flow in an exhaust flow passage between the chamber in which a substrate is subjected to predetermined processing and the exhausting pump having rotary blades rotating at high speed, and a particle trap that covers the through hole. The particle trap has a plurality of preventive members that are arranged such as to obstruct particles rebounding from the exhausting pump. The ratio of openings of the particle trap to the exhaust flow in the exhaust flow passage is not less than a predetermined value.

### BACKGROUND OF THE INVENTION

1. Field of the Invention

The present invention relates to a valve element, a particle entry preventive mechanism, an exhaust control apparatus, and a substrate processing apparatus, and in particular to a valve element, a particle entry preventive mechanism, and an exhaust control apparatus that prevent particles rebounding from an exhausting pump from entering a chamber in a substrate processing apparatus.

2. Description of the Related Art

In general, a substrate processing apparatus that subjects wafers for semiconductor devices or the like to predetermined processing has a processing chamber (hereinafter referred to as the “chamber”) in which a substrate is accommodated and subjected to predetermined processing. In the chamber, particles arising from deposit attached to an inner wall of the chamber and reaction product produced in predetermined processing are floating. If the floating particles become attached to surfaces of wafers, short circuiting of wiring will occur in products such as semiconductor devices manufactured from the wafers, resulting in decreasing the yield of the semiconductor devices. Accordingly, to remove the particles in the chamber, the substrate processing apparatus evacuates the interior of the chamber using an exhausting system.

The exhausting system of the substrate processing apparatus has a turbo-molecular pump (hereinafter referred to as the “TMP”) as an exhausting pump that can realize a high vacuum state, and an exhaust pipe that communicates the TMP and the interior of the chamber together. The TMP has a rotary shaft disposed along an exhaust flow, and a plurality of rotary blades projecting out at the right angle from the rotary shaft. Through rotation of the rotary blades about the rotary shaft at high speed, gas in front of the rotary blades is exhausted to the rear of the rotary blades at high speed. The exhausting system exhausts the particles in the chamber as well as gas in the chamber by operating the TMP.

In recent years, however, it has been found that the particles flow back into the chamber from the exhausting system. Specifically, it has been found that deposit attached to the rotary blades of the TMP separates therefrom and flows back into the chamber, or particles discharged from the chamber collide with the rotary blades of the TMP to rebound and directly flow back into the chamber.

It is thought that because the deposit separated from the rotary blades and the particles rebounded by the rotary blades are given high kinetic energy by the rotary blades rotating at high speed, they enter the chamber irrespective of the presence of an exhaust flow in the exhaust pipe.

To cope with the above described backflow of particles, the present inventors and others developed a reflecting apparatus that reflects particles rebounding from the TMP toward the TMP and a trapping mechanism that traps the particles (see, for example, Japanese Laid-open Patent Publication (Kokai) No. 2007-180467). The reflecting apparatus and the trapping mechanism described in Japanese Laid-open Patent Publication (Kokai) No. 2007-180467 are disposed in an exhaust pipe such as to substantially cover the cross-section of the exhaust pipe, and thus can reflect or trap almost all of rebounding particles.

In the reflecting apparatus and the trapping mechanism described in Japanese Laid-open Patent Publication (Kokai) No. 2007-180467, however, the ratio of openings to an exhaust flow is very small. For example, if the trapping mechanism is comprised of a resin filter, its opening ratio is less than 0.1%. This brings about a decrease in the conductance of an exhaust flow passage and a decrease in exhaust efficiency. If exhaust efficiency decreases, problems will arise, for example, the operating rate of the substrate processing apparatus will decrease because it takes a lot of time to evacuate the chamber.

### SUMMARY OF THE INVENTION

The present invention provides a valve element, a particle entry preventive mechanism, an exhaust control apparatus, and a substrate processing apparatus that can prevent particles rebounding from an exhausting pump from entering a processing chamber and also prevent a decrease in exhaust efficiency.

Accordingly, in a first aspect of the present invention, there is provided a plate-shaped valve element that is able to freely project out into an exhaust flow passage between a processing chamber in which a substrate is subjected to predetermined processing and an exhausting pump having rotary blades rotating at high speed, comprising a through opening that penetrates the valve element along an exhaust flow in the exhaust flow passage and a particle entry preventive mechanism that covers the through opening, wherein the particle entry preventive mechanism comprises a plurality of preventive members that are arranged such as to obstruct particles rebounding from the exhausting pump, and a ratio of openings of the particle entry preventive mechanism to the exhaust flow in the exhaust flow passage is not less than a predetermined value.

According to the first aspect of the present invention, because the plurality of preventive members are arranged such as to obstruct particles rebounding from the exhausting pump, and the ratio of the openings of the particle entry preventive mechanism to the exhaust flow is not less than a predetermined value, particles rebounding from the exhausting pump can be prevented from entering the processing chamber, and a decrease in exhaust efficiency can be prevented.

The first aspect of the present invention can provide a valve element, wherein the predetermined value is 90%.

According to the first aspect of the present invention, because the ratio of the openings of the particle entry preventive mechanism to the exhaust flow is not less than 90%, a decrease in exhaust efficiency can be more reliably prevented.

The first aspect of the present invention can provide a valve element, wherein respective surfaces of each of the preventive members are located so as not to make a right angle with the exhaust flow.

According to the first aspect of the present invention, because respective surfaces of each of the preventive members are located so as not to make a right angle with the exhaust flow, the preventive members are unlikely to obstruct the flow of exhaust, and as a result, a decrease in the conductance of the exhaust flow passage can be prevented.

Moreover, if each of the preventive members has a surface positioned so as to make a right angle with the passage of particles rebounding from the exhausting pump, the probability that the particles rebounding from the exhausting pump will collide with the preventive members can be increased, and as a result, the particles can be reliably prevented from entering the processing chamber.

Accordingly, in a second aspect of the present invention, there is provided a particle entry preventive mechanism disposed in an exhaust flow passage between a processing chamber in which a substrate is subjected to predetermined processing and an exhausting pump having rotary blades rotating at high speed comprising a plurality of preventive members that are arranged such as to obstruct particles rebounding from the exhausting pump, wherein a ratio of openings of the particle entry preventive mechanism to an exhaust flow in the exhaust flow passage is not less than a predetermined value.

The second aspect of the present invention can provide a particle entry preventive mechanism, wherein the plurality of preventive members are arranged radially when viewed from a direction along the exhaust flow.

According to the second aspect of the present invention, because the plurality of preventive members are arranged radially when viewed from the direction along the exhaust flow, the preventive members can be prevented from disturbing the exhaust flow passing through the particle entry preventive mechanism, and as a result, a decrease in exhaust efficiency can be reliably prevented.

The second aspect of the present invention can provide a particle entry preventive mechanism, wherein the plurality of preventive members are arranged concentrically when viewed from a direction along the exhaust flow.

According to the second aspect of the present invention, because the plurality of preventive members are arranged concentrically when viewed from a direction along the exhaust flow, the preventive members can be prevented from disturbing the exhaust flow passing through the particle entry preventive mechanism, and as a result, a decrease in exhaust efficiency can be reliably prevented.

The second aspect of the present invention can provide a particle entry preventive mechanism, wherein the predetermined value is 90%.

The second aspect of the present invention can provide a particle entry preventive mechanism, wherein respective surfaces of each of the preventive members are located so as not to make a right angle with the exhaust flow.

The second aspect of the present invention can provide a particle entry preventive mechanism, which rotates about an axis along the exhaust flow.

According to the second aspect of the present invention, because the particle entry preventive mechanism rotates about the axis along the exhaust flow, the probability that particles carried by the exhaust flow from the processing chamber will collide with the preventive members can be increased, and the probability that the preventive member will trap the particles can be increased, and therefore, the particles can be prevented from flowing from the processing chamber into the exhausting pump. As a result, particles rebounding from the exhausting pump can be fundamentally prevented from arising.

The second aspect of the present invention can provide a particle entry preventive mechanism further comprising a cooling mechanism that cools the preventive members.

According to the second aspect of the present invention, because the preventive members are cooled, a thermal migration force can be made to act on particles carried out by the exhaust flow in the vicinity of the preventive members, and as a result, the preventive members can be made to trap the particles.

The second aspect of the present invention can provide a particle entry preventive mechanism further comprising a voltage applying mechanism that applies a DC voltage to the preventive members.

According to the second aspect of the present invention, because a DC voltage is applied to the preventive members, an electrostatic force can be made to act on particles carried out by the exhaust flow in the vicinity of the preventive members, and as a result, the preventive members can be made to trap the particles.

Accordingly, in a third aspect of the present invention, there is provided an exhaust control apparatus disposed between a processing chamber in which a substrate is subjected to predetermined processing and an exhausting pump having rotary blades rotating at high speed comprising a particle entry preventive mechanism disposed in an exhaust flow passage between the processing chamber and the exhausting pump, wherein the particle entry preventive mechanism comprises a plurality of preventive members that are arranged such as to obstruct particles rebounding from the exhausting pump, and a ratio of openings of the particle entry preventive mechanism to the exhaust flow in the exhaust flow passage is not less than a predetermined value.

The third aspect of the present invention can provide an exhaust control apparatus further comprising an isolation accommodating chamber that accommodates the particle entry preventive mechanism in a manner being isolated from the exhaust flow passage and a moving mechanism that freely moves the particle entry preventive mechanism between the exhaust flow passage and the isolation accommodating chamber, wherein the isolation accommodating chamber comprises a cleaning mechanism that cleans the accommodated particle entry preventive mechanism.

According to the third aspect of the present invention, because the isolation accommodating chamber that accommodates the particle entry preventive mechanism in a manner being isolated from the exhaust flow passage has the cleaning mechanism that cleans the accommodated particle entry preventive mechanism, the exhaust flow passage does not communicate with the isolation accommodating chamber when the particle entry preventive mechanism is cleaned. Thus, it is unnecessary to expose the exhaust flow passage to the atmosphere, and a cleaning agent or the like does not enter the exhaust flow passage, and hence evacuation of the processing chamber by the exhausting pump is never obstructed, and as a result, the operating rate of the substrate processing apparatus using the exhaust control apparatus can be raised.

Moreover, according to the third aspect of the present invention, because there is the moving mechanism that moves the particle entry preventive mechanism between the exhaust flow passage and the isolation accommodating chamber, the particle entry preventive mechanism can be easily and reliably moved to the isolation accommodating chamber when the particle entry preventive mechanism has trapped a large amount of particles, and as a result, particles separated from the particle entry preventive mechanism can be prevented from dispersing into the exhaust flow passage.

The third aspect of the present invention can provide an exhaust control apparatus, wherein the cleaning mechanism uses at least one selected from a group of the following means: a substance that takes on two phases consisting of a gaseous phase and a liquid phase or a gaseous phase and a solid phase, a gaseous pulse wave, a gaseous shock wave, radicals, a cleaning solution, vibrations, and a thermal stress.

According to the third aspect of the present invention, because the cleaning mechanism uses at least one selected from a group of the following means: a substance that takes on two phases consisting of a gaseous phase and a liquid phase or a gaseous phase and a solid phase, a gaseous pulse wave, a gaseous shock wave, radicals, a cleaning solution, vibrations, and a thermal stress, the particle entry preventive mechanism can be reliably cleaned.

The third aspect of the present invention can provide an exhaust control apparatus, wherein the predetermined value is 90%.

The third aspect of the present invention can provide an exhaust control apparatus further comprising a plate-shaped valve element that is movable between the exhaust flow passage and the isolation accommodating chamber, wherein the valve element comprises a through opening that penetrates the valve element along the exhaust flow in the exhaust flow passage, and a particle entry preventive mechanism covers the through opening.

According to the third aspect of the present invention, because there is further provided the valve element that is movable between the exhaust flow passage and the isolation accommodating chamber and has the through opening covered with the particle entry preventive mechanism, the particle entry preventive mechanism can be easily and reliably moved to the isolation accommodating chamber when the particle entry preventive mechanism has trapped a large amount of particles, and as a result, particles separated from the particle entry preventive mechanism can be prevented from dispersing into the exhaust flow passage.

The third aspect of the present invention can provide an exhaust control apparatus further comprising a plurality of the particle entry preventive mechanisms of which the opening ratios are different, wherein the moving mechanism selects one of the particle entry preventive mechanisms corresponding to a desired conductance of the exhaust flow passage from the plurality of particle entry preventive mechanisms in accordance with the desired conductance, and places the selected one of the particle entry preventive mechanism in the exhaust flow passage.

According to the third aspect of the present invention, because the moving mechanism selects a particle entry preventive mechanism corresponding to a desired conductance of the exhaust flow passage from a plurality of particle entry preventive mechanisms of which the opening ratios are different in accordance with the desired conductance, and places the selected particle entry preventive mechanism in the exhaust flow passage, a desired conductance of the exhaust flow passage can be easily and reliably realized.

Accordingly, in a fourth aspect of the present invention, there is provided a substrate processing apparatus comprising a processing chamber in which a substrate is subjected to predetermined processing, an exhausting pump having rotary blades rotating at high speed and an exhaust control apparatus disposed between the processing chamber and the exhausting pump, wherein the exhaust control apparatus comprises a particle entry preventive mechanism disposed in an exhaust flow passage between the processing chamber and the exhausting pump, the particle entry preventive mechanism comprises a plurality of preventive members that are arranged such as to obstruct particles rebounding from the exhausting pump, and a ratio of openings of the particle entry preventive mechanism to an exhaust flow in the exhaust flow passage is not less than a predetermined value.

The features and advantages of the invention will become more apparent from the following detailed description taken in conjunction with the accompanying drawings.

### BRIEF DESCRIPTION OF THE DRAWINGS

FIG. 1 is a cross-sectional view schematically showing the construction of a substrate processing apparatus to which an exhaust control apparatus according to a first embodiment of the present invention is applied;

FIGS. 2A and 2B are views schematically showing the construction of an APC valve shown in FIG. 1, in which FIG. 2A is a longitudinal sectional view showing the APC valve, and FIG. 2B is a horizontal sectional view showing the APC valve;

FIGS. 3A, 3B, and 3C are views schematically showing the construction of a particle trap shown in FIGS. 2A and 2B, in which FIG. 3A is a plan view showing the particle trap, FIG. 3B is a side view showing the particle trap, and FIG. 3C is a view showing how the particle trap prevents the entry of particles;

FIGS. 4A, 4B, and 4C are process drawings useful in explaining a collision between the rotating particle trap and a particle carried by an exhaust flow;

FIGS. 5A, 5B, and 5C are process drawings useful in explaining how the particle trap traps a particle through a thermal migration force;

FIGS. 6A, 6B, and 6C are views schematically showing the construction of a variation of the particle trap, in which FIG. 6A is a plan view showing the particle trap, FIG. 6B is a side view showing the particle trap, and FIG. 6C is a view showing how the particle trap prevents the entry of particles;

FIGS. 7A and 7B are views schematically showing the construction of an APC valve as an exhaust control apparatus according to a second embodiment of the present invention, in which FIG. 7A is a longitudinal sectional view showing the APC valve, and FIG. 7B is a horizontal sectional view showing the APC valve;

FIGS. 8A and 8B are plan views schematically showing the constructions of particle traps having different opening ratios from the opening ratio of the particle trap shown in FIGS. 3A, 3B, and 3C, in which FIG. 8A shows the particle trap in some of preventive members are replaced with wider preventive members, and FIG. 8A shows the particle trap in all of a preventive members are replaced with wider preventive members; and

FIG. 9 is a cross-sectional view schematically showing variations of locations at which a trap cleaning chamber, a gate valve, and an arm mechanism shown in FIGS. 7A and 7B are disposed.

### DETAILED DESCRIPTION OF PREFERRED EMBODIMENTS

The present invention will now be described in detail with reference to the drawings showing preferred embodiments thereof.

First, a description will be given of a substrate processing apparatus to which an exhaust control apparatus according to a first embodiment of the present invention is applied.

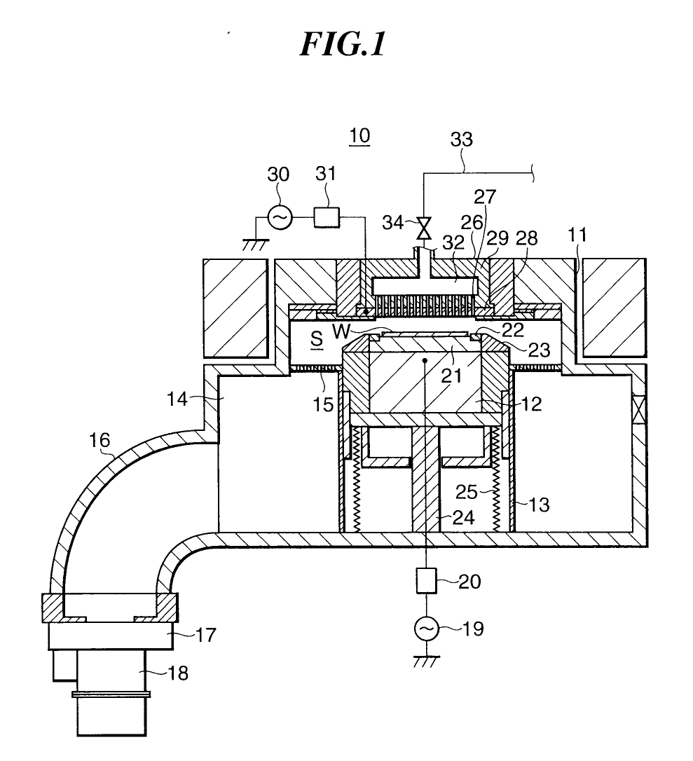

FIG. 1 is a cross-sectional view schematically showing the construction of the substrate processing apparatus to which the exhaust control apparatus according to the present embodiment is applied.

Referring to FIG. 1, the substrate processing apparatus 10 constructed as an etching processing apparatus that subjects semiconductor wafers (hereinafter referred to merely as “wafers”) W to reactive ion etching (hereinafter referred to as the “RIE”) processing has a chamber 11 (processing chamber) that is made of a metal such as aluminum or stainless steel and formed by placing a cylindrical member having a smaller diameter over a cylindrical member having a larger diameter.

In the chamber 11 are disposed a lower electrode 12 as a wafer stage on which a wafer W is mounted and that rises and lowers with the wafer W in the chamber 11, and a cylindrical cover 13 that covers a side of the rising and lowering lower electrode 12.

An annular baffle plate 15 that separates an exhaust chamber 14 from a processing space S, which is a space above the lower electrode 12, is disposed on a side of the lower electrode 12, and the exhaust chamber 14 communicates with a TMP 18, which is an exhausting pump for evacuation, via an exhaust manifold 16 and an automatic pressure control (hereinafter referred to as the “APC”) valve 17 (exhaust control apparatus), which is a variable slide valve.

The TMP 18 reduces the pressure in the chamber 11 down to a substantially vacuum state, and the APC valve 17 controls the pressure in the chamber 11 when the chamber 11 is evacuated. The baffle plate 15 has a plurality of circular vent holes that communicate the processing space S and the exhaust chamber 14 together.

A lower radio-frequency power source 19 is connected to the lower electrode 12 via a lower matcher 20, and the lower radio-frequency power source 19 applies predetermined radio-frequency electrical power to the lower electrode 12. The lower matcher 20 reduces the reflection of the radio-frequency electrical power from the lower electrode 12 so as to maximize the efficiency of input of the radio-frequency electrical power to the lower electrode 12.

An ESC 21 for attracting the wafer W by electrostatic attraction is disposed in an upper portion of the lower electrode 12. A DC power source (not shown) is electrically connected to the ESC 21. The wafer W is attracted to and held on an upper surface of -the ESC 21 through a Johnsen-Rahbek force or a Coulomb force generated by a DC voltage applied to the ESC 21 from the DC power source. Moreover, an annular focus ring 22 made of silicon (Si) or the like is disposed at a peripheral edge of the ESC 21. The focus ring 22 focuses ions and radicals produced in the processing space S toward the wafer W. Moreover, the focus ring 22 is surrounded by an annular cover ring 23.

A support 24 provided so as to extend from a lower portion of the lower electrode 12 downward is disposed below the lower electrode 12. The support 24 supports the lower electrode 12, and raises and lowers the lower electrode 12. Moreover, the support 24 is surrounded by a bellows cover 25 so as to be cut off from the atmosphere in the chamber 11.

In the substrate processing apparatus 10, when a wafer W is to be transferred into or out from the chamber 11, the lower electrode -12 is lowered down to a transferring in/out position for the wafer W, and when the RIE processing is to be carried out on the wafer W, the lower electrode 12 is raised up to a processing position for the wafer W.

A showerhead 26 that supplies a process gas, described later, into the chamber 11 is disposed in a ceiling portion of the chamber 11. The showerhead 26 has a disk-shaped upper electrode 28 that has therein a large number of gas vent holes 27, and an electrode support 29 that is disposed above the upper electrode 28 and on which the upper electrode 28 is detachably supported.

An upper radio-frequency power source 30 is connected to the upper electrode 28 via an upper matcher 31, and the upper radio-frequency power source 30 applies predetermined radio-frequency electrical power to the upper electrode 28. The upper matcher 31 reduces the reflection of the radio-frequency electrical power from the upper electrode 28 so as to maximize the efficiency of input of the radio-frequency electrical power to the upper electrode 28.

A buffer chamber 32 is provided inside the electrode support 29. A process gas introducing pipe 33 is connected to the buffer chamber 32, and a valve 34 is disposed part way along the process gas introducing pipe 33. A process gas that is comprised of, for example, silicon tetrahydride (SiH₄), oxygen gas (O₂), argon gas (Ar), and carbon tetrafluoride (CF₄) singly or in combination is introduced from the process gas introducing pipe 33 into the buffer chamber 32, and the introduced process gas is supplied into the processing space S via the gas vent holes 27.

In the chamber 11 of the substrate processing apparatus 10, radio-frequency electrical power is applied to the lower electrode 12 and the upper electrode 28 as described above, and high-density plasma is generated from the process gas in the processing space S by the applied radio-frequency electrical power, whereby ions and radicals are produced. The produced ions and radicals are focused onto the surface of the wafer W by the focus ring 22 to physically or chemically etch the surface of the wafer W.

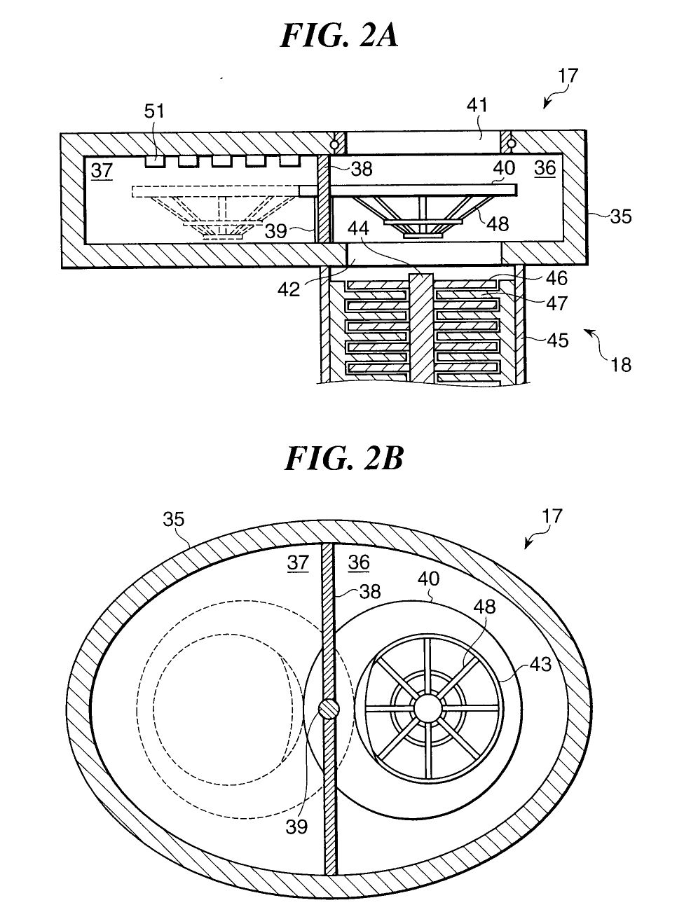

FIGS. 2A and 2B are views schematically showing the construction of the APC valve shown in FIG. 1, in which FIG. 2A is a longitudinal sectional view showing the APC valve, and FIG. 2B is a horizontal sectional view showing the APC valve.

Referring to FIGS. 2A and 2B, the APC valve 17 has a main body 35 comprised of a container that is oval in plan view, a gate valve 38 that is located roughly in the center of the main body 35 and partitions the interior of the main body 35 into an exhaust flow passage chamber 36 and a trap cleaning chamber 37 (isolation accommodating chamber), and a valve element 40 that is horizontally movable inside the main body 35.

Moreover, referring to FIG. 2A, the TMP 18 has a rotary shaft 44 disposed in a vertical direction as viewed in the figure, that is, in the direction of an exhaust flow, a cylindrical member 45 disposed parallel to the rotary shaft 44 such as to accommodate the rotary shaft 44, a plurality of rotary blades 46 that vertically project out from the rotary shaft 44, and a plurality of stationary blades 47 that project out from the inner peripheral surface of the cylindrical member 47 toward the rotary shaft 44.

The plurality of rotary blades 46 radially project out from the rotary shaft 44 to form rotary blade groups, and the plurality of stationary blades 47 are arranged at regular intervals on the same circumference of the inner peripheral surface of the cylindrical member 45 and project out toward the rotary shaft 44 to form stationary blade groups. In the TMP 18, there are a plurality of groups of rotary blades and a plurality of groups of stationary blades. Respective rotary blade groups are disposed at regular intervals along the rotary shaft 44, and each of the stationary blade groups is disposed between adjacent two rotary blades.

Generally, in the TMP 18, the uppermost rotary blade group is disposed at a higher level than the uppermost stationary blade group. That is, the uppermost rotary blade group is disposed closer to the exhaust manifold than the uppermost stationary blade group. Moreover, in the TMP 18, the rotary blades 46 are rotated at high speed about the rotary shaft 44, whereby gas is exhausted rapidly from the exhaust manifold 16 to below the TMP 18.

The exhaust flow passage chamber 36 is interposed between the exhaust manifold 16 and the TMP 18. The exhaust flow passage chamber 36 communicates with the exhaust manifold 16 via an upper opening 41 as a circular hole, and communicates with the TMP 18 via a lower opening 42 as a circular hole. Referring to FIG. 2A, the upper opening 41 and the lower opening 42 are coaxially arranged, and exhaust gas flows from the upper opening 41 toward the lower opening 42.

The valve element 40 is disk-shaped, and moves while rotating about a shaft 39 located roughly in the center of the main body 35, thus moving back and forth between the exhaust flow passage chamber 36 and the trap cleaning chamber 37. When the valve element 40 moves into the exhaust flow passage chamber 36 and projects out into the exhaust flow passage chamber 36, the valve element 40 is positioned between the upper opening 41 and the lower opening 42 and obstruct the exhaust flow by projecting vertically to the exhaust flow. Moreover, by moving while rotating, the valve element 40 varies the obstructed amount of exhaust flow to adjust the exhaust flow rate, thus controlling the pressure in the exhaust manifold 16, and by extension the pressure in the processing space S.

The valve element 40 has such a size as to hide the entire lower opening 42 from the upper opening 41 as shown in FIG. 2B when projecting out into the exhaust flow passage chamber 36 to the maximum extent possible. However, the valve element 40 has a through hole 43 (through opening) that penetrates therethrough from the upper opening 41 toward the lower opening 42 at a position corresponding to the upper opening 41 (lower opening 42) when projecting out into the exhaust flow passage chamber 36 to the maximum extent possible. The diameter of the through hole 43 is substantially the same as the diameter of the upper opening 41 and the lower opening 42 when viewed from a direction along the exhaust flow.

Moreover, the valve element 42 has a particle trap 48 (particle entry preventive mechanism) that covers the through hole 43 on the TMP 18 side.

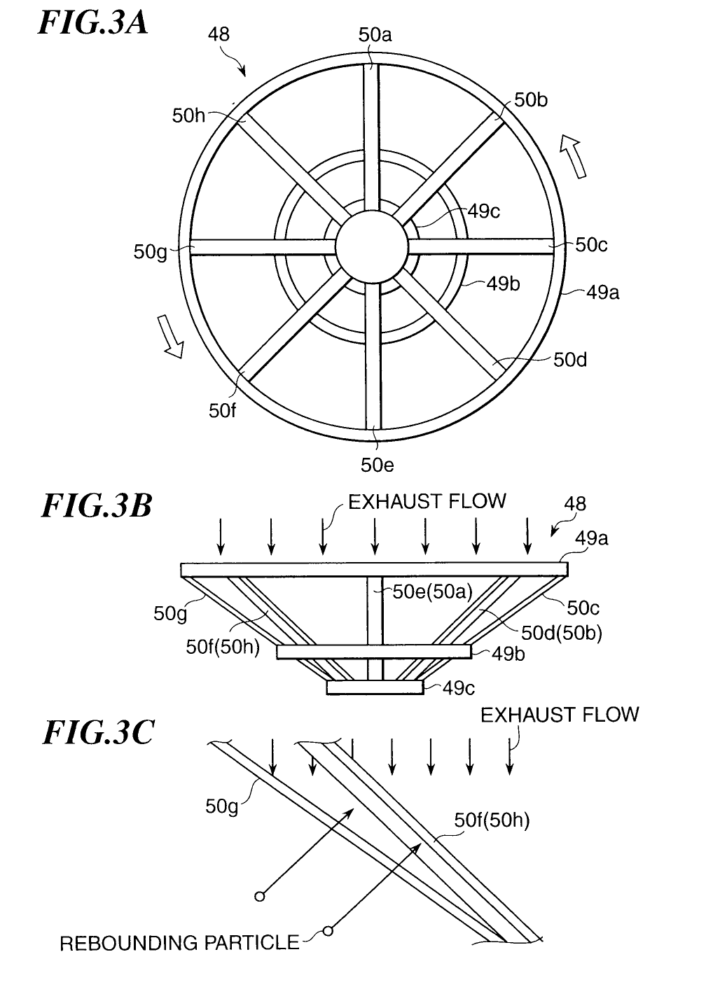

FIGS. 3A, 3B, and 3C are views schematically showing the construction of the particle trap shown in FIGS. 2A and 2B, in which FIG. 3A is a plan view showing the particle trap, FIG. 3B is a side view showing the particle trap, and FIG. 3C is a view showing how the particle trap prevents the entry of particles. The exhaust flow in the exhaust flow passage chamber 36 goes in the direction of depth as viewed in FIG. 3A and from top down as viewed in FIG. 3B.

Referring to FIGS. 3A and 3B, the particle trap 48 has three annular members 49a, 49b, and 49c that have different diameters and are arranged concentrically when viewed from the direction along the exhaust flow, and thin plate-shaped preventive members 50a to 50h that bridge the annular members 49a, 49b, and 49c and are arranged radially in order from the smallest annular member 49c when viewed from the direction along the exhaust flow.

In the particle trap 48, the area of portions i.e. openings that are not covered with the annular members 49a, 49b, and 49c and the preventive members 50a to 50h is, for example, not less than 90% of the whole area (the area of the circle having the outer diameter of the annular member 49a). Hereafter, the ratio of the area of the openings to the whole area when the particle trap 48 is viewed from the direction along the exhaust flow will be referred to as the opening ratio. The greater the opening ratio is, the smaller the extent to which the exhaust flow is obstructed. It has been ascertained that if the through hole 43 of the valve element 40 corresponds to the lower opening 42 when viewed from the direction along the exhaust flow, that is, if not only the through hole 43 but also the lower opening 42 is indirectly covered with the particle trap 48, the conductance of an exhaust flow passage comprised of the upper opening 41, through hole 43, and lower opening 42 does not decrease as long as the opening ratio of the particle trap 48 is not less than 90%.

In the particle trap 48, the smaller the diameters of the three annular members 49a, 49b, and 49c are, the more downstream (closer to the TMP 18) they are disposed, and hence the preventive members 50a to 50h that bridge the annular members 49a, 49b, and 49c are disposed oblique to the exhaust flow (indicated by the arrows in FIG. 3B). Thus, surfaces of the preventive members 50a to 50h are disposed oblique to the exhaust flow, not to make a right angle with the exhaust flow.

Here, because in the TMP 18, the uppermost rotary blade group is disposed closer to the exhaust manifold 16 than the uppermost stationary blade group, particles that are discharged from the chamber 11 and reach the TMP 18 collide with the rotary blades 46 and rebound upward, that is, toward the exhaust manifold 16. At this time, because the rotary blades 46 are rotating at high speed, almost all of energy which the particles receive from the rotary blades 46 through the collision is kinetic energy in the direction of rotation of the rotary blades 46. Moreover, the direction of rotation of the rotary blades 46 is vertical to the exhaust flow. As a result, the direction in which the particles rebound is oblique to the exhaust flow.

Here, because the surfaces of the preventive members 50a to 50h are disposed oblique to the exhaust flow, as described above, the preventive members 50a to 50h obstruct the passages of the rebounding particles. In particular, the angles at which the preventive members 50a to 50h of the particle trap 48 are mounted on the annular members 49a, 49b, and 49c are adjusted such that part of their surfaces are located so as not to make a right angle with the passages of the rebounding particles. Thus, the probability that the rebounding particles will collide with the surfaces of the preventive members 50a to 50h can be increased, and the preventive members 50a to 50h prevent the rebounding particles from entering the exhaust manifold 16, and by extension the processing space S of the chamber 11. In particular, if the surfaces of the preventive members 50a to 50h are covered with mesh-like members (for example, mesh-like members comprised of any of SUS, Teflon (registered trademark), silica (SiO₂), and alumina (Al₂O₃)), the rebounding particles colliding with the surfaces of the preventive members 50a to 50h are trapped by the mesh-like members, and hence the rebounding particles can be more reliably prevented from entering the processing space S of the chamber 11.

Moreover, the particle trap 48 rotates about an axis along the exhaust flow. Specifically, if the rotary blades 46 of the TMP 18 rotate clockwise when viewed from the direction along the exhaust flow, the particle trap 48 rotates counterclockwise about the central point of the annular members 49a, 49b, and 49c, and if the rotary blades 46 of the TMP 18 rotate counterclockwise when viewed from the direction along the exhaust flow, the particle trap 48 rotates clockwise about the central point of the annular members 49a, 49b, and 49c (FIG. 3A).

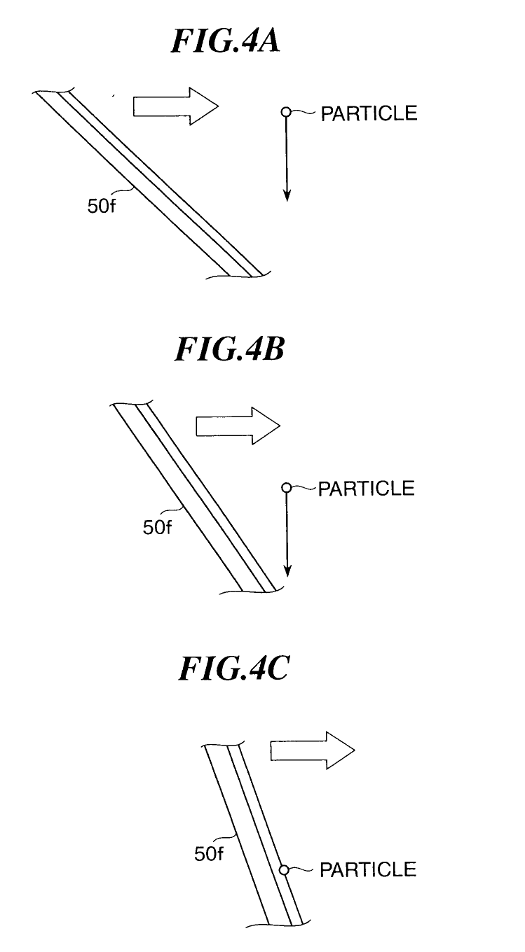

When the particle trap 48 rotates about the axis along the exhaust flow, the probability that particles carried by the exhaust flow (particles flowing from the chamber 11 toward the TMP 18) will collide with the preventive members 50a to 50h when passing through the particle trap 48 can be increased, and the probability that the preventive members 50a to 50h will trap the particles can be increased. For example, as shown in FIGS. 4A to 4C, the preventive member 50f which does not lie on the passage of a particle when the particle starts passing through the particle trap 48 (FIG. 4A) is made to approach the passage of the particle through rotation of the particle trap 48 (FIG. 4B), and in the end, collides with and traps the particle (FIG. 4C). In this way, the particle trap 48 not only prevents rebounding particles from entering the processing space S of the chamber 11, but also prevents particles carried by the exhaust flow from flowing into the TMP 18.

It is preferred that the rotation speed of the particle trap 48 is not less than a speed at which a certain preventive member 50 can move to a position at which its neighboring preventive member 50 was present (for example, a speed at which the preventive member 50f can move to a position at which the preventive member 50e was present as viewed in FIG. 3A, that is, a speed at which the particle trap 48 rotates ⅛ revolution) while a particle is passing through the particle trap 48. In this case, each of the preventive members 50a to 50h can scan an opening when viewed from the direction along the exhaust flow while a particle is passing through the particle trap 48, and as a result, the probability that the particle passing through the opening will be trapped can be further increased.

Because the opening ratio of the particle trap 48 does not change even when the particle trap 48 rotates, the rotation of the particle trap 48 never obstructs the exhaust flow. Rather, if the preventive members 50a to 50h are formed in blade-shaped, and the particle trap 48 is constructed such that the particle trap 48 itself produces a flow into the TMP 18, exhaust efficiency in the processing space S of the chamber 11 can be further increased.

Moreover, it is known that a thermal migration force arising from the difference in temperature between particles in the atmosphere acts on particles in an evacuated atmosphere, for example, an atmosphere at a pressure of several mTorr to several Torr. Specifically, the particles are attracted to an object having a low temperature. In the present embodiment, the particle trap 48 is equipped with a cooling mechanism (not shown) such as a Peltier device or a coolant passage so as to use the thermal migration force, and the cooling mechanism cools the preventive members 50a to 50h.

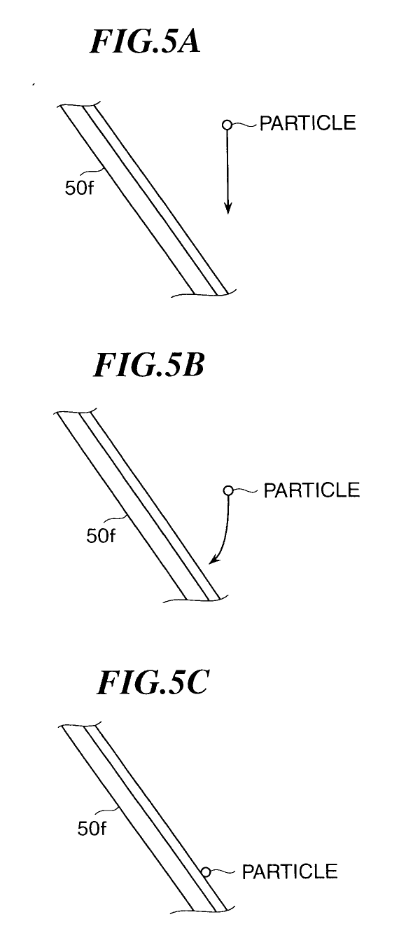

The pressure in the exhaust flow is several Torr at most, and hence if the preventive members 50a to 50h are cooled, particles carried by the exhaust flow are attracted to the preventive members 50a to 50h through a thermal migration force acting thereon when the particles are passing through the particle trap 48, in particular, areas near the preventive members 50a to 50h, and as a result, the probability that the preventive members 50a to 50h will trap the particles can be increased. For example, as shown in FIGS. 5A to 5C, when a particle starts passing through the particle trap 48 (FIG. 5A), the direction of the passages of the particle is changed toward the preventive member 50f through a thermal migration force (FIG. 5B) even if the preventive member 50f does not lie on the passage of the particle, and in the end, the particle collides with the preventive member 50f and is trapped by the preventive member 50f (FIG. 5C) In this way as well, the particle trap 48 can prevent particles carried by the exhaust flow from flowing into the TMP 18.

Referring again to FIGS. 2A and 2B, the gate valve 38 in the APC valve 17 is constructed such as to be openable and closable, and when the valve element 40 moves from the exhaust flow passage chamber 36 to the trap cleaning chamber 37 or moves from the trap cleaning chamber 37 to the exhaust flow passage chamber 36, the gate valve 38 opens to bring the exhaust flow passage chamber 36 and the trap cleaning chamber 37 into communication with each other. Moreover, when the APC valve 17 controls the pressure in the chamber 11 or cleans the particle trap 48 of the valve element 40 that has moved to the trap cleaning chamber 37, the gate valve 38 closes to separate the trap cleaning chamber 37 from the exhaust flow passage chamber 36.

If the particle trap 48 of the valve element 40 continues to prevent rebounding particles from entering the processing space S of the chamber 11, the amount of particles trapped by the surfaces of the preventive members 50a to 50h increases. The increase in the amount of trap particles is significant on the surfaces located so as not to make a right angle with the passages of the rebounding particles, in particular. If the amount of trapped particles increases, then the probability that the particles will drop or separate from the preventive members 50a to 50h when a certain external force is exerted on the particle trap 48 increases. The separated particles may flow into the TMP 18 and rebound.

To cope with this, the TMP 18 according to the present embodiment cleans the particle trap 48. Specifically, the trap cleaning chamber 37 is equipped with a cleaning mechanism 51 for the particle trap 48. Examples of the cleaning mechanism 51 include a unit that jets a cleaning substance taking on two phases i.e. a gaseous phase and a liquid phase or a gaseous phase and a solid phase (that is, in aerosol form) toward the particle trap 48, a unit that jets heated water vapor toward the particle trap 48, a unit that sprays a gas such as an inert gas in the form of a pulsating wave toward the particle trap 48, a unit that adds a shock wave of a gas such as an inert gas toward the particle trap 48, a unit that supplies plasma such as oxygen radicals toward the particle trap 48, a unit that sprays a cleaning solution in a liquid phase as it is toward the particle trap 48, a unit that immerses the particle trap 48 in a cleaning solution tank, a unit that gives vibrations to the particle trap 48, and a unit that gives heat cycles to the particle trap 48 to separate particles from the particle trap 48 through a thermal stress.

In the case that a cleaning substance in aerosol form is jetted to the particle trap 48, it is preferred that the cleaning substance is heated and jetted such that the temperature of the cleaning substance when reaching the particle trap 48 can be about 80° C., so that not only a cleaning effect by the cleaning substance but also a cleaning effect by a thermal stress can be expected to be obtained, and the particle trap 48 can be quickly and reliably cleaned. In the case that plasma is supplied to the particle trap 48, the plasma may be produced in the trap cleaning chamber 37, or plasma produced by a remote plasma producing unit may be introduced into the trap cleaning chamber 37.

In a conventional substrate processing apparatus, to clean tools and so on disposed in an exhaust flow passage, it is necessary to expose the exhaust flow passage to the atmosphere so as to take out the tools. If the exhaust flow passage is exposed to the atmosphere, however, the pressure in the processing space S of the chamber 11 returns to atmospheric pressure, and hence it is necessary to carry out exhausting (evacuation) for reducing the pressure in the processing space S after the tools are cleaned.

On the other hand, in the substrate processing apparatus 10, when the cleaning mechanism 51 cleans the particle trap 48, the trap cleaning chamber 37 is isolated from the exhaust flow passage chamber 36 by the gate valve 38, and hence, for example, even if the trap cleaning chamber 37 is exposed to the atmosphere so as to improve a cleaning effect, the pressure in the exhaust flow passage chamber 36, and by extension the pressures in the exhaust manifold 16 and the processing space S of the chamber 11 do not return to atmospheric pressure. Moreover, a cleaning agent jetted from the cleaning mechanism 51 and particles removed from the particle trap 48 do not flow back into the exhaust flow passage chamber 36, and by extension the processing space S. Therefore, the need to carry out evacuation for reducing the pressure in the processing space S after the particle trap 48 is cleaned can be eliminated, and as a result, the operating rate of the substrate processing apparatus 10 can be raised, and the processing space S of the chamber 11 can be prevented from accidentally becoming contaminated by particles.

According to the APC valve 17 as the exhaust control apparatus of the present embodiment, because the preventive members 50a to 50h of the particle trap 48 are arranged such as to obstruct the passages of particles rebounding from the TMP 18, and the operating ratio of the particle trap 48 when viewed from the direction along the exhaust flow is not less than 90%, rebounding particles can be prevented from entering the processing space of the chamber 11, and the conductance of the exhaust flow passage can be prevented from decreasing, so that a decrease in exhaust efficiency due to the TMP 18 can be prevented.

Moreover, because in the particle trap 48, the surfaces of the preventive members 50a to 50h are located so as not to make a right angle with the exhaust flow, the preventive members 50a to 50h are unlikely to obstruct the exhaust flow, and as a result, a decrease in the conductance of the exhaust flow passage can be reliably prevented.

Further, because in the particle trap 48, the preventive members 50a to 50h are disposed radially when viewed from the direction along the exhaust flow, the exhaust flow passing through the particle trap 48 can be prevented from becoming disturbed, and as a result, a decrease in exhaust efficiency can be reliably prevented.

Moreover, because in the APC valve 17 described above, the valve element 40 can easily and reliably move the particle trap 48 to the trap cleaning chamber 37 when the particle trap 48 has trapped a large amount of particles, particles separated from the preventive members 50a to 50h of the particle trap 48 can be prevented from dispersing into the exhaust manifold 16.

Although the particle trap 48 described above is equipped the cooling mechanism, the particle trap 48 may be equipped with a voltage applying mechanism that applies a positive DC voltage to the preventive members 50a to 50h in addition to the cooling mechanism.

Particles flowing from the processing space of the chamber 11 are negatively charged in many cases, and hence if a positive DC voltage is applied to the preventive members 50a to 50h, the particles can be attracted to the preventive members 50a to 50h through an electrostatic force. As a result, the probability that the preventive members 50a to 50h will trap the particles can be increased.

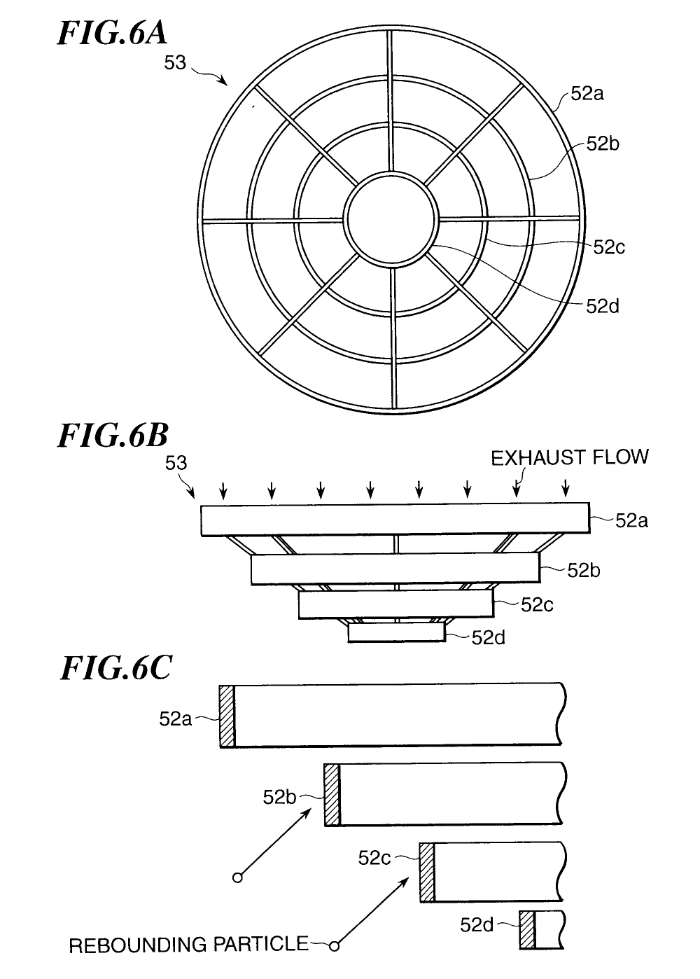

Moreover, in the particle trap 48, the preventive members 50a to 50h are disposed radially when viewed from the direction along the exhaust flow, a plurality of cylindrical preventive members 52a to 52d having different diameters may be disposed concentrically when viewed from the direction along the exhaust flow as shown in FIGS. 6A and 6B. The smaller the diameters of the preventive members 52a to 52d are, the more downstream of the exhaust flow (closer to the TMP 18) they are disposed. Moreover, the lengths of the preventive members 52a to 52d are not less than a predetermined value, and the intervals between neighboring preventive members 52 as viewed in the direction along the exhaust flow are small enough, and hence the preventive members 52a to 52d obstruct the passages of rebounding particles (FIG. 6C). On the other hand, the preventive members 52a to 52d are constructed such as to be small in thickness, and hence the ratio of openings to the exhaust flow is very high, for example, not less than 90%.

For the reasons stated above, a particle trap 53 shown in FIGS. 6A and 6B as well can prevent rebounding particles from entering the processing space S of the chamber 11 and a decrease in exhaust efficiency due to the TMP 18 can be prevented. Moreover, because in the particle trap 53, the preventive members 52a to 52d are disposed concentrically when viewed from the direction along the exhaust flow, the exhaust flow passing through the particle trap 53 can be prevented from becoming disturbed, and as a result, a decrease in exhaust efficiency can be reliably prevented.

Next, a description will be given of an exhaust control apparatus according to a second embodiment of the present invention.

The present embodiment is basically the same as the first embodiment described above in terms of construction and operation, differing from the first embodiment in that the valve element and the particle trap are not configured as an integral unit. Features of the construction and operation that are the same as in the first embodiment will thus not be described, only features that are different from those of the first embodiment being described below.

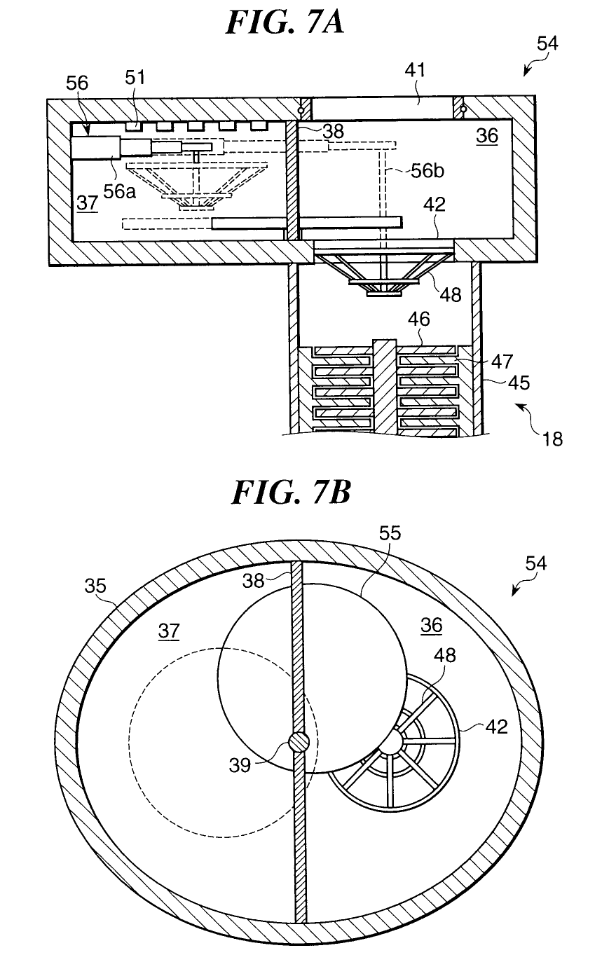

FIGS. 7A and 7B are views schematically showing the construction of an APC valve as the exhaust control apparatus according to the present embodiment, in which FIG. 7A is a longitudinal sectional view showing the APC valve, and FIG. 7B is a horizontal sectional view showing the APC valve.

Referring to FIGS. 7A and 7B, the APC valve 54 has a valve element 55 that is horizontally movable inside the main body 35, and an arm mechanism 56 (moving mechanism) capable of moving the particle trap 48 between the exhaust flow passage chamber 36 and the trap cleaning chamber 37, as well as the main body 35 and the gate valve 38.

The valve element 55 is disk-shaped, and moves while rotating about the shaft 39 located roughly in the center of the main body 35, thus moving back and forth between the exhaust flow passage chamber 36 and the trap cleaning chamber 37. When the valve element 55 moves into the exhaust flow passage chamber 36 and projects out into the exhaust flow passage chamber 36, the valve element 55 projects out vertically to the exhaust flow, thus obstructing the exhaust flow. Moreover, the valve element 55 varies the obstructed amount of exhaust flow to adjust the exhaust flow rate, thus controlling the pressure in the exhaust manifold 16, and by extension the pressure in the processing space S. It should be noted that the valve element 55 does not have a through hole like the through hole 43 provided in the valve element 40.

The arm mechanism 56 has an arm portion 56a that is constructed such as to be able to extend in a horizontal direction (direction perpendicular to the exhaust flow), and a trap raising/lowering belt 56b that is disposed at a distal end of the arm portion 56a, and suspends and raises/lowers the particle trap 48.

To prevent rebounding particles from the TMP 18 from entering the processing space S, the arm portion 56a extends to transfer the particle trap 48 into the exhaust flow passage chamber 36, and further, the trap raising/lowering belt 56b lowers the particle trap 48 and inserts the particle trap 48 into the lower opening 42. At this time, the particle trap 48 is inserted into the lower opening 42 such that the preventive members 50a to 50h are disposed radially when viewed from the direction along the exhaust flow, and the surfaces of the preventive members 50a to 50h obstruct the passages of the rebounding particles. As a result, the rebounding particles can be prevented from entering the processing space S of the chamber 11, and the conductance of the exhaust flow passage can be prevented from decreasing, so that a decrease in exhaust efficiency due to the TMP 18 can be prevented. Here, after inserting the particle trap 48 into the lower opening 42a, the arm mechanism 56 may separate the trap raising/lowering belt 56b from the particle trap 48 and accommodate the trap raising/lowering belt 56b in the trap cleaning chamber 37 while keeping the particle trap 48 inserted in the lower opening 42.

Moreover, because in the case that the particle trap 48 has trapped a large amount of particles, the arm mechanism 56 can easily and reliably move the particle trap 48 to the trap cleaning chamber 37, the arm mechanism 56 can prevent particles separated from the preventive members 50a to 50h of the particle trap 48 from dispersing into the exhaust manifold 16.

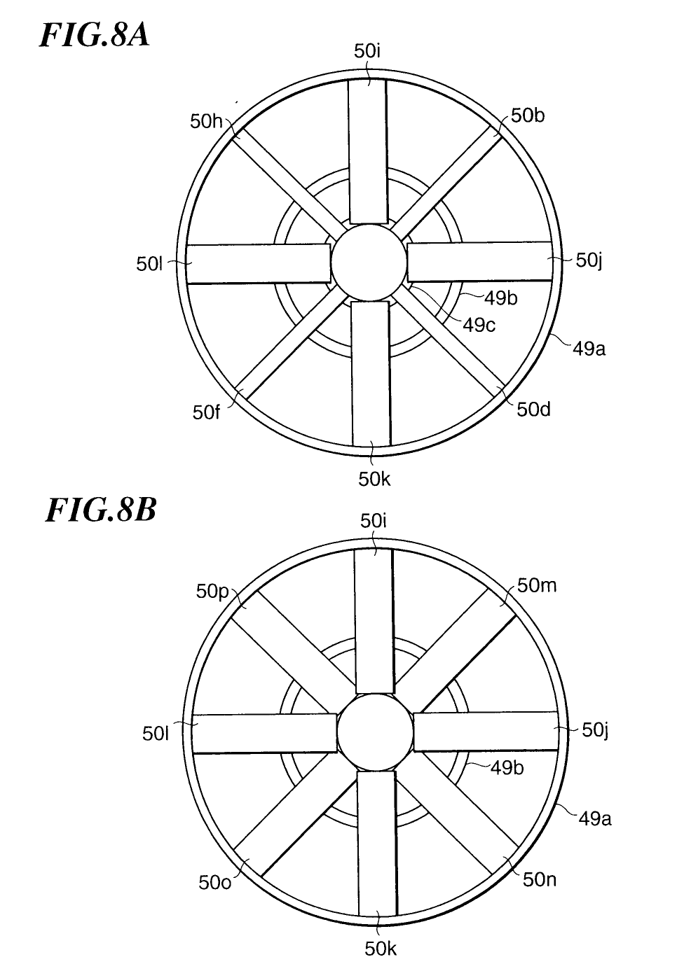

Although the APC valve 54 described above is provided with only one particle trap, the APC valve 54 may be provided with a plurality of particle traps having different opening ratios from the opening ratio of the particle trap 48 as shown in FIGS. 8A and 8B. If a particle trap having a different opening ratio is inserted into the lower opening 42, the amount of exhaust flow obstructed by the particle trap can be changed, and therefore the conductance of the exhaust flow passage can be changed.

Thus, if a particle trap having a predetermined opening ratio is selected in accordance with a desired conductance of the exhaust flow passage and inserted into the lower opening 42 by the arm mechanism 56, the particle trap can realize the desired conductance in collaboration with the valve element 55 or by itself. That is, by interchanging particle traps having different opening ratios, a desired conductance of the exhaust flow passage can be easily and reliably realized.

To realize particle traps having different opening ratios, it is preferred that some or all of the preventive members 50a to 50h are replaced with wider preventive members (50i to 50p) as shown in FIGS. 8A and 8B.

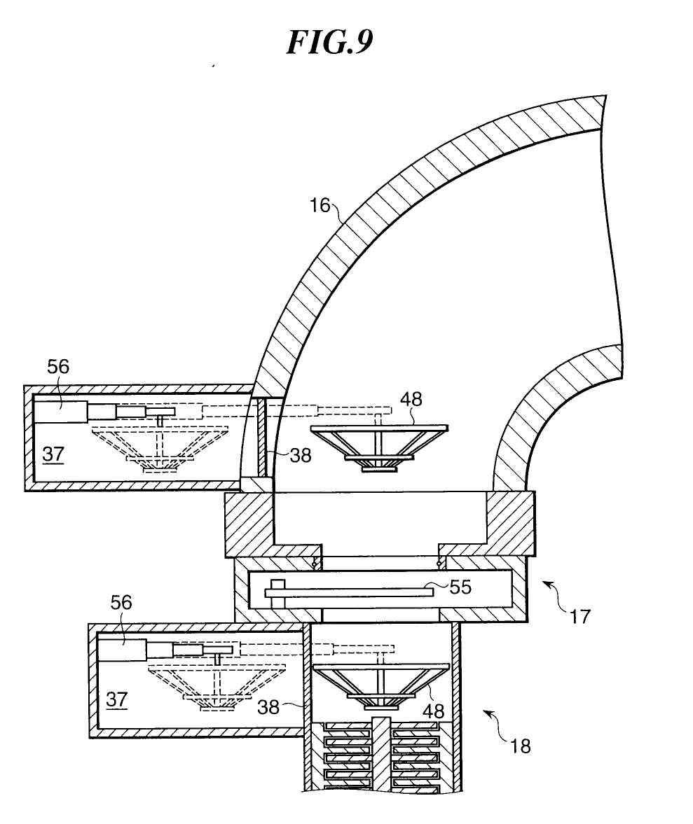

Although in the present embodiment, the trap cleaning chamber 37, gate valve 38 and arm mechanism 56 are disposed in the APC valve 54, the trap cleaning chamber 37, gate valve 38, and arm mechanism 56 should not necessarily be disposed in the APC valve 54. For example, as shown in FIG. 9, the trap cleaning chamber 37, gate valve 38, and arm mechanism 56 may be disposed part way along the exhaust manifold 16, or in a manifold portion of the TMP 18. In either case, it is only necessary for the arm mechanism 56 to place the particle trap 48 in the exhaust flow, and also, it is only necessary for the gate valve 38 to separate the exhaust flow and the trap cleaning chamber 37 from each other. It goes without saying that in either case, the trap cleaning chamber 37 is preferably provided with the cleaning mechanism 51. In either case, by using the particle trap 48, rebounding particles can be prevented from entering the processing space S of the chamber 11, and a decrease in exhaust efficiency due to the TMP 18 can be prevented.

Although in the above described embodiments, the substrates subjected to the RIE processing in the chamber 11 are semiconductor wafers, the substrate subjected to the RIE processing are not limited to them and rather may instead be any of various glass substrates used in LCDs (Liquid Crystal Displays), FPDs (Flat Panel Displays), or the like.

What is claimed is:

1. A plate-shaped valve element that is able to freely project out into an exhaust flow passage between a processing chamber in which a substrate is subjected to predetermined processing and an exhausting pump having rotary blades rotating at high speed, comprising:
a through opening that penetrates the valve element along an exhaust flow in the exhaust flow passage; and
a particle entry preventive mechanism that covers said through opening,
wherein said particle entry preventive mechanism comprises a plurality of preventive members that are arranged such as to obstruct particles rebounding from the exhausting pump, and
a ratio of openings of said particle entry preventive mechanism to the exhaust flow in the exhaust flow passage is not less than a predetermined value.

2. A valve element as claimed in claim 1, wherein the predetermined value is 90%.

3. A valve element as claimed in claim 1, wherein respective surfaces of each of said preventive members are located so as not to make a right angle with the exhaust flow.

4. A particle entry preventive mechanism disposed in an exhaust flow passage between a processing chamber in which a substrate is subjected to predetermined processing and an exhausting pump having rotary blades rotating at high speed, comprising:
a plurality of preventive members that are arranged such as to obstruct particles rebounding from the exhausting pump,
wherein a ratio of openings of said particle entry preventive mechanism to an exhaust flow in the exhaust flow passage is not less than a predetermined value.

5. A particle entry preventive mechanism as claimed in claim 4, wherein said plurality of preventive members are arranged radially when viewed from a direction along the exhaust flow.

6. A particle entry preventive mechanism as claimed in claim 4, wherein said plurality of preventive members are arranged concentrically when viewed from a direction along the exhaust flow.

7. A particle entry preventive mechanism as claimed in claim 4, wherein the predetermined value is 90%.

8. A particle entry preventive mechanism as claimed in claim 4, wherein respective surfaces of each of said preventive members are located so as not to make a right angle with the exhaust flow.

9. A particle entry preventive mechanism as claimed in claim 4, which rotates about an axis along the exhaust flow.

10. A particle entry preventive mechanism as claimed in claim 4, further comprising a cooling mechanism that cools said preventive members.

11. A particle entry preventive mechanism as claimed in claim 4, further comprising a voltage applying mechanism that applies a DC voltage to said preventive members.

12. An exhaust control apparatus disposed between a processing chamber in which a substrate is subjected to predetermined processing and an exhausting pump having rotary blades rotating at high speed, comprising:
a particle entry preventive mechanism disposed in an exhaust flow passage between the processing chamber and the exhausting pump,
wherein said particle entry preventive mechanism comprises a plurality of preventive members that are arranged such as to obstruct particles rebounding from the exhausting pump, and
a ratio of openings of said particle entry preventive mechanism to the exhaust flow in the exhaust flow passage is not less than a predetermined value.

13. An exhaust control apparatus as claimed in claim 12, further comprising:
an isolation accommodating chamber that accommodates said particle entry preventive mechanism in a manner being isolated from the exhaust flow passage; and
a moving mechanism that freely moves said particle entry preventive mechanism between the exhaust flow passage and said isolation accommodating chamber,
wherein said isolation accommodating chamber comprises a cleaning mechanism that cleans said accommodated particle entry preventive mechanism.

14. An exhaust control apparatus as claimed in claim 13, wherein said cleaning mechanism uses at least one selected from a group of the following means: a substance that takes on two phases consisting of a gaseous phase and a liquid phase or a gaseous phase and a solid phase, a gaseous pulse wave, a gaseous shock wave, radicals, a cleaning solution, vibrations, and a thermal stress.

15. An exhaust control apparatus as claimed in claim 12, wherein the predetermined value is 90%.

16. An exhaust control apparatus as claimed in claim 13, further comprising a plate-shaped valve element that is movable between the exhaust flow passage and said isolation accommodating chamber,
wherein said valve element comprises a through opening that penetrates said valve element along the exhaust flow in the exhaust flow passage, and
a particle entry preventive mechanism covers said through opening.

17. An exhaust control apparatus as claimed in claim 13, further comprising a plurality of said particle entry preventive mechanisms of which the opening ratios are different,
wherein said moving mechanism selects one of said particle entry preventive mechanisms corresponding to a desired conductance of the exhaust flow passage from said plurality of particle entry preventive mechanisms in accordance with the desired conductance, and places the selected one of said particle entry preventive mechanism in the exhaust flow passage.

18. A substrate processing apparatus comprising:
a processing chamber in which a substrate is subjected to predetermined processing;
an exhausting pump having rotary blades rotating at high speed; and
an exhaust control apparatus disposed between said processing chamber and said exhausting pump,
wherein said exhaust control apparatus comprises a particle entry preventive mechanism disposed in an exhaust flow passage between said processing chamber and said exhausting pump,
said particle entry preventive mechanism comprises a plurality of preventive members that are arranged such as to obstruct particles rebounding from said exhausting pump, and
a ratio of openings of said particle entry preventive mechanism to an exhaust flow in the exhaust flow passage is not less than a predetermined value.
